(19) United States
(12) Patent Application Publication
(10) Pub. No.: US 2023/0067998 A1
(43) Pub. Date: Mar. 2, 2023

(54) MAINTENANCE MANAGEMENT DEVICE, MAINTENANCE MANAGEMENT SYSTEM MAINTENANCE MANAGEMENT METHOD, AND STORAGE MEDIUM

(71) Applicant: HONDA MOTOR CO., LTD., Tokyo (JP)

(72) Inventors: Tomohisa Suzuki, Tokyo (JP); Sho Ohkado, Tokyo (JP); Hiroki Kanaeda, Tokyo (JP)

(21) Appl. No.: 17/889,413

(22) Filed: Aug. 17, 2022

(30) Foreign Application Priority Data
Aug. 30, 2021 (JP) 2021-140246

(51) Int. Cl. G06Q 10/02; G06Q 10/10; G06Q 10/00

(52) U.S. Cl. CPC G06Q 10/02; G06Q 10/1095; G06Q 10/20

(57) ABSTRACT

According to an embodiment, a maintenance management device includes an acquirer configured to acquire a maintenance request for a vehicle, a manager configured to manage information about maintenance facilities where vehicle maintenance is possible, and a selector configured to select a maintenance facility for requesting the vehicle maintenance on the basis of information about a desired date of a user of the vehicle, a place, and maintenance content included in the maintenance request acquired by the acquirer and the information about the maintenance facilities.

### CROSS-REFERENCE TO RELATED APPLICATION

Priority is claimed on Japanese Patent Application No. 2021-140246, filed Aug. 30, 2021, the content of which is incorporated herein by reference.

### BACKGROUND

### Field of the Invention

The present invention relates to a maintenance management device, a maintenance management system, a maintenance management method, and a storage medium.

### Description of Related Art

Conventionally, when vehicle maintenance such as checking or parts replacement of a vehicle and a vehicle inspection is carried out, a maintenance shop capable of carrying out user-desired maintenance is searched for, a telephone reservation for the maintenance shop that has been found is made or a web reservation is made using the Internet, the vehicle is moved to the maintenance shop on a reservation date, and the maintenance is able to be carried out in the maintenance shop. In this regard, technology in which, when a user inputs a prescribed condition on a website, data about a maintenance shop corresponding to the condition can be obtained is known (for example, Japanese Unexamined Patent Application, First Publication No. 2002-92210).

### SUMMARY

However, because the conventional technology requires a process of searching for a maintenance facility capable of carrying out user-desired maintenance and often involves direct communication between the maintenance facility that has been found and a user, the burden on the user may increase. During the vehicle maintenance, a service form that allows the user to spend the waiting time meaningfully has not been taken into account. Therefore, it may be difficult to provide a more appropriate maintenance facility in response to a vehicle maintenance request from a user.

An aspect of the present invention is made in consideration of such circumstances and an objective of the present invention is to provide a maintenance management device, a maintenance management system, a maintenance management method, and a storage medium capable of providing a more appropriate maintenance facility in response to a vehicle maintenance request.

A maintenance management device, a maintenance management system, a maintenance management method, and a storage medium according to the present invention adopt the following configurations.

(1): According to an aspect of the present invention, there is provided a maintenance management device including: an acquirer configured to acquire a maintenance request for a vehicle; a manager configured to manage information about maintenance facilities where vehicle maintenance is possible; and a selector configured to select a maintenance facility for requesting the vehicle maintenance on the basis of information about a desired date of a user of the vehicle, a place, and maintenance content included in the maintenance request acquired by the acquirer and the information about the maintenance facilities.

(2): In the above-described aspect (1), the manager manages vehicle information of the user and notifies the user of information for requesting the user to perform the vehicle maintenance on the basis of the vehicle information.

(3): In the above-described aspect (1), the manager notifies the maintenance facility managed by the manager of the maintenance request acquired by the acquirer and the selector selects the maintenance facility for requesting the vehicle maintenance on the basis of the maintenance information for the vehicle acquired by the acquirer from the maintenance facility.

(4): In the above-described aspect (1), when the acquirer has acquired maintenance information for the vehicle from a plurality of maintenance facilities, the selector notifies the user of the maintenance information for the vehicle in relation to each maintenance facility and selects a maintenance facility selected by the user as the maintenance facility for requesting the vehicle maintenance.

(5): In the above-described aspect (1), the place includes one or both of a vehicle pick-up place and a vehicle drop-off place.

(6): In the above-described aspect (1), the place is a place where there is no maintenance facility.

(7): In the above-described aspect (1), the place is an excursion destination visited by the user for a purpose other than the vehicle maintenance.

(8): According to another aspect of the present invention, there is provided a maintenance management system including a user terminal used by a user of a vehicle, maintenance facilities where vehicle maintenance is possible, and a maintenance management device configured to communicate with the user terminal and the maintenance facilities, wherein the maintenance management device includes an acquirer configured to acquire a maintenance request for the vehicle input through the user terminal; a manager configured to manage maintenance facility information based on the maintenance request from the maintenance facilities; a selector configured to select a maintenance facility for requesting the vehicle maintenance on the basis of information about a desired date of a user of the vehicle, a place, and maintenance content included in the maintenance request acquired by the acquirer and the maintenance facility information; and an information provider configured to provide information based on a selection result of the selector to the user terminal and the maintenance facility selected by the selector.

(9): According to yet another aspect of the present invention, there is provided a maintenance management method including: acquiring, by a computer, a maintenance request for a vehicle; managing, by the computer, information about maintenance facilities where vehicle maintenance is possible; and selecting, by the computer, a maintenance facility for requesting the vehicle maintenance on the basis of information about a desired date of a user of the vehicle, a place, and maintenance content included in the acquired maintenance request and the information about the maintenance facilities.

(10): According to yet another aspect of the present invention, there is provided a computer-readable non-transitory storage medium storing a program for causing a computer to: acquire a maintenance request for a vehicle; manage information about maintenance facilities where vehicle maintenance is possible; and select a maintenance facility for requesting the vehicle maintenance on the basis of information about a desired date of a user of the vehicle, a place, and maintenance content included in the acquired maintenance request and the information about the maintenance facilities.

According to the above-described aspects (1) to (10), it is possible to provide a more appropriate maintenance facility in response to a vehicle maintenance request.

### BRIEF DESCRIPTION OF THE DRAWINGS

FIG. 1 is a configuration diagram of a maintenance management system including a maintenance management server according to an embodiment.

FIG. 2 is a diagram for describing content of user information.

FIG. 3 is a diagram for describing content of vehicle information.

FIG. 4 is a diagram for describing content of maintenance facility information.

FIG. 5 is a configuration diagram of a user terminal according to the embodiment.

FIG. 6 is a configuration diagram of a facility terminal according to the embodiment.

FIG. 7 is a diagram for describing an example of a series of processes related to vehicle maintenance according to the embodiment.

FIG. 8 is a diagram showing an example of a maintenance guide image displayed on the user terminal.

FIG. 9 is a diagram showing an example of a maintenance reservation image.

FIG. 10 is a diagram showing an example of a maintenance reservation image.

FIG. 11 is a diagram showing an example of an additional confirmation image.

FIG. 12 is a sequence diagram showing an example of a process executed by the maintenance management system according to the embodiment.

FIG. 13 is a sequence diagram showing an example of another process executed by the maintenance management system according to the embodiment.

### DESCRIPTION OF EMBODIMENTS

Hereinafter, embodiments of a maintenance management device, a maintenance management system, a maintenance management method, and a storage medium of the present invention will be described with reference to the drawings. In the following description, a maintenance target vehicle is, for example, a vehicle such as a two-wheeled vehicle, a three-wheeled vehicle, or a four-wheeled vehicle. A driving source of these vehicles is an internal combustion engine such as a diesel engine or a gasoline engine, an electric motor, or a combination thereof. The electric motor operates using electric power generated by a power generator connected to the internal combustion engine or power that is supplied when a secondary battery or a fuel cell is discharged. The vehicle may include a communication function (a communicator) for communicating with an external device and a human machine interface (HMI) for inputting/outputting information. The HMI includes, for example, a speaker, a display device, a buzzer, a touch panel, a switch, a key, and the like.

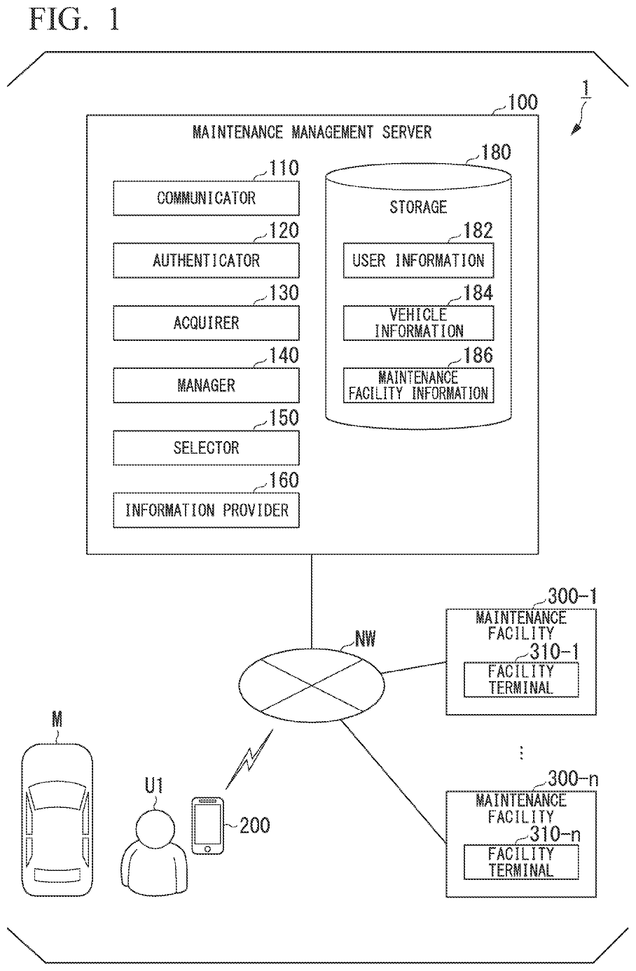

FIG. 1 is a configuration diagram of a maintenance management system 1 including a maintenance management server according to an embodiment. The maintenance management system 1 includes, for example, a maintenance management server 100, a user terminal 200 used by a user U1 of the maintenance management system 1, and a plurality of maintenance facilities 300-1 to 300-n (n is a natural number greater than or equal to 2). These components can communicate with each other via a network NW. The network NW includes the Internet, a wide area network (WAN), a local area network (LAN), a telephone circuit, a public circuit, a dedicated circuit, a provider device, a radio base station, and the like. The maintenance management server 100 is an example of a “maintenance management device.” Hereinafter, except for the case where each of the plurality of maintenance facilities 300-1 to 300-n is identified and described, they will be simply referred to as “maintenance facilities 300” in the description. Likewise, the facility terminals 310-1 to 310-n, which will be described below, will be referred to simply as “facility terminals 310.” The user U1 is, for example, an owner of a maintenance target vehicle M. The user terminal 200 may be, for example, a portable terminal such as a smartphone or a tablet terminal or may be a stationary personal computer (PC) or the like. The maintenance facility 300 is a facility where vehicle maintenance is possible. Maintenance includes, for example, checking (maintenance) of the vehicle M, replacement of parts (car parts), a vehicle inspection, and the like. The maintenance facilities 300 include, for example, a maintenance shop, a repair shop, a vehicle dealer (for example, a dealer), a car parts store, and the like. The maintenance facility 300 may be a facility under the jurisdiction of a specific company (for example, an automobile manufacturer) or may include a facility managed by a plurality of different companies or individuals. The maintenance facility 300 may include a terminal device (the facility terminal 310) that communicates with the maintenance management server 100 and the user terminal 200 via the network NW. The maintenance management system 1 shown in FIG. 1 may manage a plurality of users and information about a user terminal and vehicle for each user.

### [Maintenance Management Server]

The maintenance management server 100 includes, for example, a communicator 110, an authenticator 120, an acquirer 130, a manager 140, a selector 150, an information provider 160, and a storage 180. The authenticator 120, the acquirer 130, the manager 140, the selector 150, and the information provider 160 are implemented, for example, by a hardware processor such as a central processing unit (CPU) executing a program (software). Some or all of the above components may be implemented by hardware (including a circuit; circuitry) such as a large-scale integration (LSI) circuit, an application specific integrated circuit (ASIC), a field-programmable gate array (FPGA), or a graphics processing unit (GPU) or may be implemented by software and hardware in cooperation. The program may be prestored in a storage device (a storage device including a non-transitory storage medium) such as an HDD or a flash memory or may be stored in a removable storage medium (the non-transitory storage medium) such as a DVD or a CD-ROM and installed in the storage device of the maintenance management server 100 when the storage medium is mounted in a drive device or the like. The maintenance management server 100 may function as a cloud server that communicates with the user terminal 200, the vehicle M, and the maintenance facility 300 (the facility terminal 310) via the network NW to transmit and receive various types of data or may function as a web server.

The storage 180 may be implemented by the above-described various storage devices, an EEPROM, a ROM, a RAM, or the like. The storage 180 stores, for example, user information 182, vehicle information 184, maintenance facility information 186, programs, and various other types of information. Details of the user information 182, the vehicle information 184, and the maintenance facility information 186 will be described below.

The communicator 110 communicates with the user terminal 200, the vehicle M, the maintenance facility 300 (the facility terminal 310), and other external devices via the network NW.

The authenticator 120 registers information about a user (for example, the user U1) who uses the maintenance management system 1. Specifically, the authenticator 120 receives information about the user U1 from the user terminal 200 and stores the received information in the user information 182 of the storage 180.

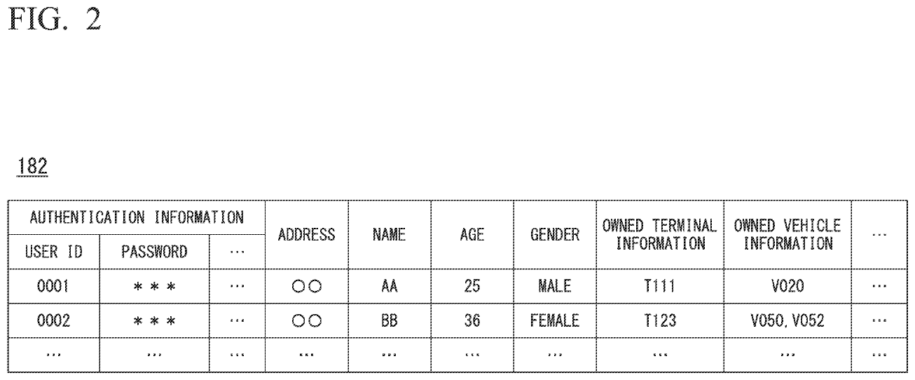

FIG. 2 is a diagram for describing content of the user information 182. The user information 182 is, for example, information in which an address, a name, an age, a gender, owned terminal information, owned vehicle information, and the like are associated with authentication information for authenticating the user when the maintenance management system 1 is used. The authentication information includes, for example, a user ID, a password, and the like, which are identification information for identifying the user. The authentication information may include biometric information such as fingerprint information and iris information. The owned terminal information includes, for example, a telephone number, an e-mail address, and terminal identification information (for example, a terminal ID) assigned to the user terminal 200 owned by the user U1. The owned vehicle information includes information such as a vehicle ID, a vehicle type, and a color, which are identification information for identifying the vehicle M owned by the user U1. The owned vehicle information may include information such as address information and a telephone number for communicating with the vehicle M. The owned vehicle information may include information about an image of the vehicle M. The image of the vehicle M may be, for example, an image captured by the user U1 using the user terminal 200 or may be an image captured in the maintenance facility 300 at the time of past maintenance. The maintenance management server 100 communicates with the user terminal 200 on the basis of the owned terminal information and communicates with the vehicle M on the basis of the owned vehicle information. Thereby, the maintenance management server 100 can provide a notification to the user U1 via the user terminal 200, the HMI of the vehicle M, or the like and can acquire information input by the user's operation.

For example, when the user terminal 200 receives a user registration request, the authenticator 120 generates an image for inputting various types of information included in the user information 182, causes the terminal device that has received the request to display the image, and acquires user information input from the user terminal 200.

The authenticator 120 authenticates the user U1 who uses a service of the maintenance management system 1 on the basis of the registered user information 182. For example, the authenticator 120 authenticates the user U1 at a timing when a service usage request has been received from the user terminal 200. For example, when the usage request has been received, the authenticator 120 generates an authentication image for inputting authentication information such as a user ID and a password, causes the generated image to be displayed on the user terminal 200 from which the request has been received, and determines whether or not to permit the use of the service (the maintenance management system 1) according to whether or not authentication information matching the input authentication information is stored with reference to the authentication information of the user information 182 on the basis of the input authentication information input using the displayed image. For example, the authenticator 120 performs a process of permitting the use of the service when the authentication information matching the input authentication information is included in the user information 182 and denying the use of the service when the matching information is not included or causing new registration to be performed. The authenticator 120 may perform authentication similar to the above-described user authentication with respect to the maintenance facility 300.

The acquirer 130 acquires the vehicle information of the user U1 from the user terminal 200. The vehicle information includes, for example, owned vehicle information, a maintenance history, a mileage, vehicle verification information, and the like corresponding to the vehicle M. The maintenance history is a past maintenance history of the vehicle M (for example, a failure location or a replaced part, a maintenance period, repair content, costs, and the like). The maintenance history may include information about a maintenance facility where maintenance has been carried out, privilege information at that time, and the like. The mileage is a total mileage (a cumulated mileage) of the vehicle M. The vehicle verification information includes, for example, information such as a vehicle number, a type (a vehicle type), and a vehicle inspection expiration date. The acquirer 130 stores the acquired vehicle information in the vehicle information 184 and the like. The acquirer 130 may be acquired the vehicle information from the maintenance facility 300 where maintenance was carried out in the past as well as the user terminal 200.

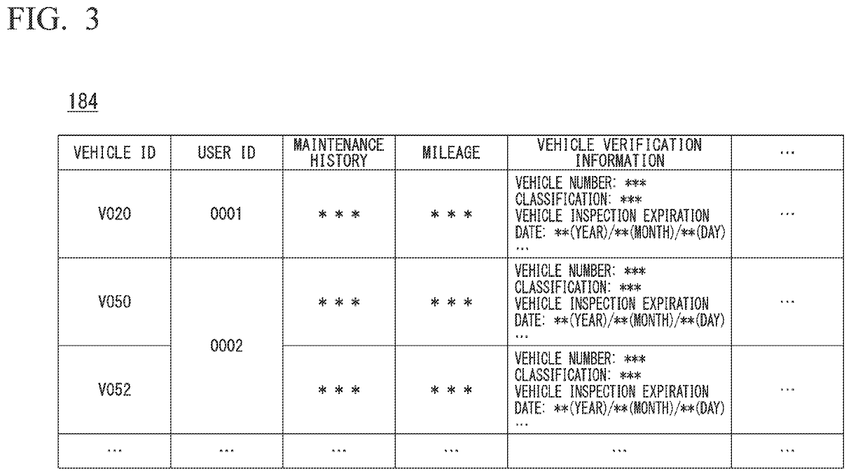

FIG. 3 is a diagram for describing content of the vehicle information 184. The vehicle information 184 is, for example, information in which a user ID, a maintenance history, a mileage, and vehicle verification information are associated with a vehicle ID. The user ID is identification information for identifying the user who owns the vehicle M. The vehicle ID is information included in the owned vehicle information of the user information 182. The vehicle information 184 may be included in the user information 182.

The acquirer 130 acquires information about the maintenance facility from the maintenance facility 300 (the facility terminal 310) and stores the acquired information as maintenance facility information 186 in the storage 180. The maintenance facility information is an example of maintenance information for the vehicle M whose maintenance has been requested.

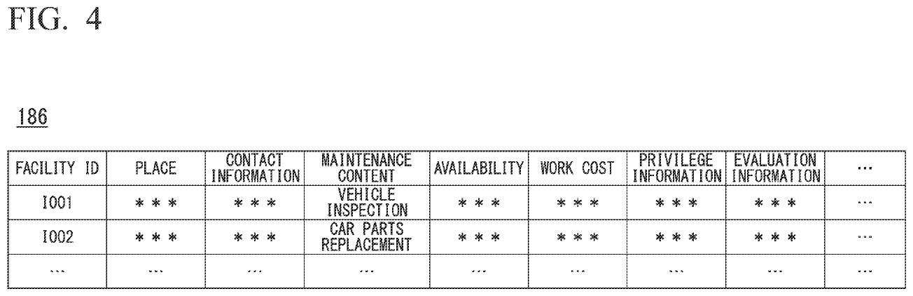

FIG. 4 is a diagram for describing content of the maintenance facility information 186. The maintenance facility information 186 is, for example, information in which a place, contact information, maintenance content, availability, work cost, privilege information, and evaluation information are associated with an identification ID which is identification information for identifying a maintenance facility. The place is a place related to a place of the maintenance facility 300. The contact information includes address information, a telephone number, and the like for communicating with the maintenance facility 300 (the facility terminal 310). The maintenance content includes the content of maintenance capable of being carried out by the maintenance facility 300 (for example, a vehicle inspection, car parts replacement, and repair). The availability is, for example, information about the availability of the maintenance facility 300 or workers. The availability may include information about the number of vehicles for which maintenance is possible. The privilege information includes, for example, information (for example, a car wash service, a discount, point grant, or a free gift) about the privileges (service) when the service (maintenance) of the maintenance facility 300 has been used. The evaluation information includes information about a facility evaluation result of the user who used the maintenance facility 300 in the past. The evaluation result is acquired, for example, by making an inquiry to the user terminal 200 of the user U1 who used the maintenance facility in the past.

The manager 140 manages users who use the maintenance management system 1, manages vehicle information, manages maintenance facility information, and the like. The manager 140 manages the maintenance of the vehicle M. Details of the function of the manager 140 will be described below.

When the maintenance request for the vehicle M has been acquired, the selector 150 selects a maintenance facility 300 for requesting the maintenance corresponding to the maintenance request. Details of the function of the selector 150 will be described below.

The information provider 160 provides various types of information to the user terminal 200, the vehicle M, and the maintenance facility 300 (the facility terminal 310). The information provider 160 generates, for example, information such as images and sounds to be provided to the user terminal 200 or the vehicle M and the maintenance facility 300, and provides the generated information. For example, the information provider 160 provides the user terminal 200 and/or the vehicle M with information about a maintenance period associated with a vehicle inspection or the like and provides the user terminal 200 and/or the vehicle M with information about the maintenance facility 300. For example, the information provider 160 provides the maintenance facility 300 with information about the vehicle M whose maintenance has been requested and provides the maintenance facility 300 with information about the user U1.

### [User Terminal]

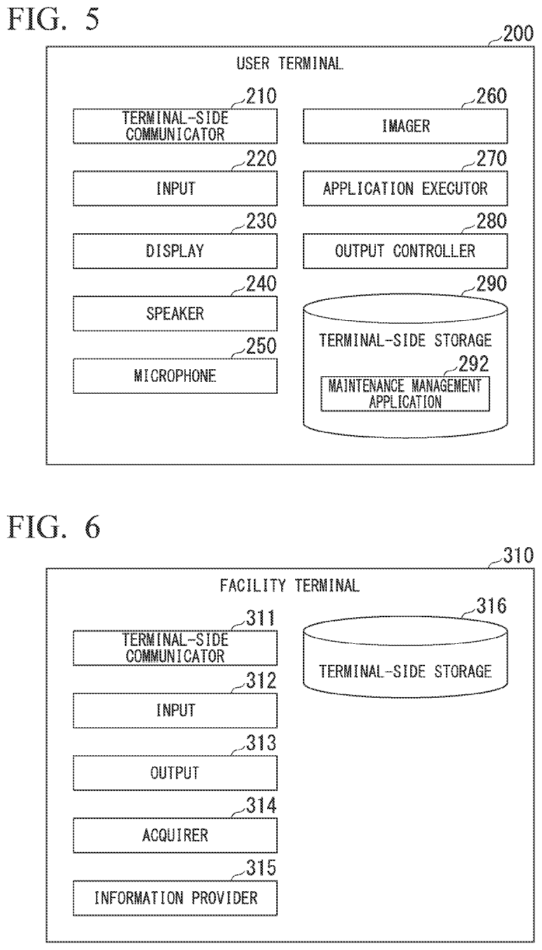

Next, a configuration of the user terminal 200 will be described. FIG. 5 is a configuration diagram of the user terminal 200 according to the embodiment. The user terminal 200 includes, for example, a terminal-side communicator 210, an input 220, a display 230, a speaker 240, a microphone 250, an imager 260, an application executor 270, an output controller 280, and a terminal-side storage 290. The application executor 270 and the output controller 280 are implemented, for example, by a hardware processor such as a CPU executing a program (software). Some or all of the above components may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory or may be stored in a removable storage medium (the non-transitory storage medium) such as a DVD or a CD-ROM and installed in the storage device of the user terminal 200 when the storage medium is mounted in a drive device, a card slot, or the like.

The terminal-side storage 290 may be implemented by the above-described various types of storage devices, an EEPROM, a ROM, a RAM, or the like. For example, the maintenance management application 292, the program, and various other types of information are stored in the terminal-side storage 290.

The terminal-side communicator 210 communicates with the maintenance management server 100, the maintenance facility 300, and other external devices using, for example, the network NW.

For example, the input 220 receives an input of the user U1 by operating various types of keys, buttons, and the like. The display 230 is, for example, a liquid crystal display (LCD), an organic electro luminescence (EL) display, or the like. The input 220 may be integrally configured with the display 230 as a touch panel. The display 230 displays various types of information according to the embodiment under the control of the output controller 280. The speaker 240 outputs a prescribed sound, for example, under the control of the output controller 280. For example, the microphone 250 receives a voice input of the user U1 under the control of the output controller 280.

The imager 260 is a digital camera that uses a solid-state image sensor (an image sensor) such as a charge coupled device (CCD) or a complementary metal oxide semiconductor (CMOS). For example, the imager 260 captures an image including a main body of the vehicle M of a maintenance target, a prescribed area in a vehicle cabin, a replacement target part, or the like according to an operation of the user U1.

The application executor 270 is implemented by executing a maintenance management application 292 stored in the terminal-side storage 290. The maintenance management application 292, for example, downloaded from an external device via the network NW, is installed in the user terminal 200. The maintenance management application 292 is an application program for controlling the output controller 280 such that an image provided from the maintenance management server 100 is output to the display 230 with respect to the user U1 and a sound corresponding to information provided from the maintenance management server 100 is output from the speaker 240. The application executor 270 transmits information input by the input 220 to the maintenance management server 100 and/or the facility terminal 310 via the terminal-side communicator 210.

The output controller 280 controls content and a display mode of the image to be displayed on the display 230 and content and an output mode of the sound to be output by the speaker 240 under the control of the application executor 270.

### [Maintenance Facility (Facility Terminal)]

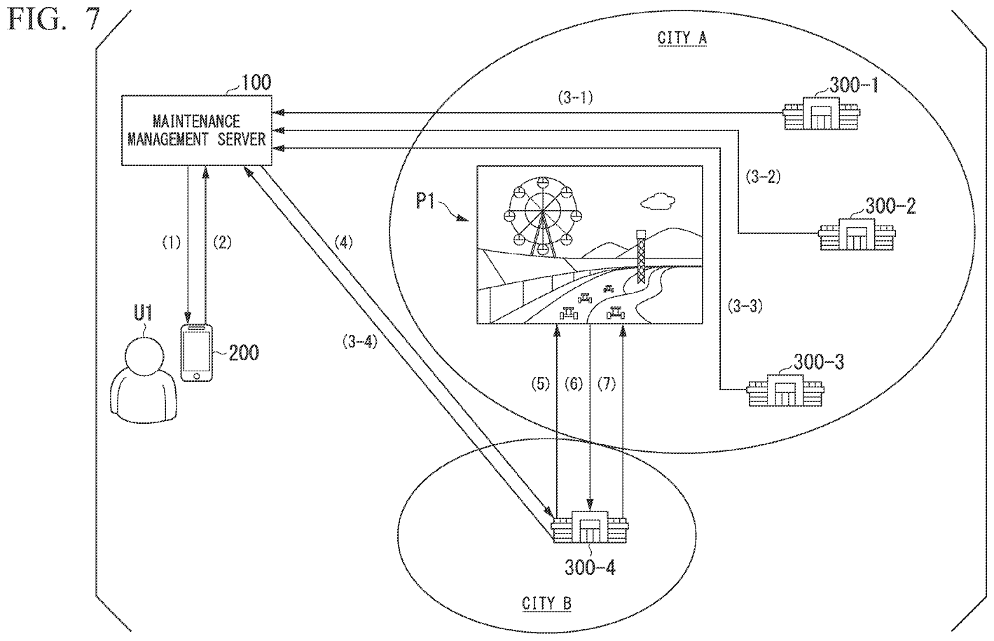

Next, a configuration of the facility terminal 310 of the maintenance facility 300 will be described. FIG. 6 is a configuration diagram of the facility terminal 310 according to the embodiment. The facility terminal 310 may be a smartphone or a tablet terminal or may be a stationary personal computer (PC). The facility terminal 310 includes, for example, a terminal-side communicator 311, an input 312, an output 313, an acquirer 314, an information provider 315, and a terminal-side storage 316. The acquirer 314 and the information provider 315 are implemented, for example, by a hardware processor such as a CPU executing a program (software). Some or all of the above components may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory or may be stored in a removable storage medium (the non-transitory storage medium) such as a DVD or a CD-ROM and installed in the storage device of the facility terminal 310 when the storage medium is mounted in a drive device, a card slot, or the like.

The terminal-side storage 316 may be implemented by the above-described various types of storage devices, an EEPROM, a ROM, a RAM, or the like. For example, a program and various other types of information are stored in the terminal-side storage 316. The various types of information include, for example, maintenance facility information and information acquired from the maintenance management server 100, the user terminal 200, or the vehicle M.

The terminal-side communicator 311 communicates with the maintenance management server 100, the user terminal 200, the vehicle M, and other external devices using, for example, the network NW. The input 312 receives an input from an administrator of the maintenance facility 300, for example, by operating various types of keys, buttons, and the like. The output 313 includes, for example, a display, a speaker, and the like. The display is, for example, an LCD, an organic EL display, or the like. The input 312 may be integrally configured with the display as a touch panel. The display displays information acquired by the acquirer 314, information stored in the terminal-side storage 316, and the like. The speaker outputs, for example, a prescribed sound. The acquirer 314 acquires various types of information from the maintenance management server 100 and/or the user terminal 200. The acquired information may be output by the output 313 or may be stored in the terminal-side storage 316.

The information provider 315 provides information (for example, contact information, maintenance content, availability, work cost, and privilege information) corresponding to a request for acquiring maintenance facility information from the maintenance management server 100. The information provider 315 provides the vehicle M whose maintenance has been requested with information indicating that the target maintenance can be carried out, information about costs and privileges, and the like. In this case, the information provider 315 may provide the information corresponding to the maintenance request whose notification has been directly provided to the maintenance facility 300 and may access the maintenance management server 100 and provide information corresponding to the maintenance request published on the web. For example, the information provider 315 may generate information such as images and sounds to be provided to the maintenance management server 100, the user terminal 200, and the vehicle M, and provide the generated information.

### [Flow of a Series of Processes Related to Vehicle Maintenance]

Next, a series of processes related to the maintenance of the vehicle M of the embodiment will be described with reference to the drawings. FIG. 7 is a diagram for describing an example of a series of processes related to the maintenance of the vehicle M according to the embodiment. (1) to (7) shown in FIG. 7 show the order of the processes related to maintenance. In the process of FIG. 7, it is assumed that the user U1 is permitted to use the maintenance management system 1 by the authenticator 120. Although information is transmitted and received between the maintenance management server 100 and the user terminal 200 in the following description, the vehicle M may be used instead of the user terminal 200. In the following description, it is assumed that communication with the maintenance facility 300 includes communication with the facility terminal 310.

In the example of FIG. 7, the manager 140 of the maintenance management server 100 refers to the vehicle verification information of the vehicle information 184, generates an image (a maintenance guide image) including guide information for requesting inspection/maintenance of the vehicle M when the number of days from a current point of time (a current date) to a vehicle inspection expiration date is within the prescribed number of days, and provides a notification to the user U1 by transmitting the generated image to the user terminal 200 of the user U1 who is an owner of the vehicle M ((1) of FIG. 7). The user terminal 200 of the user U1 is identified by owned terminal information associated with a matching vehicle ID, for example, with reference to owned vehicle information of the user information 182 on the basis of the vehicle ID included in the vehicle information 184.

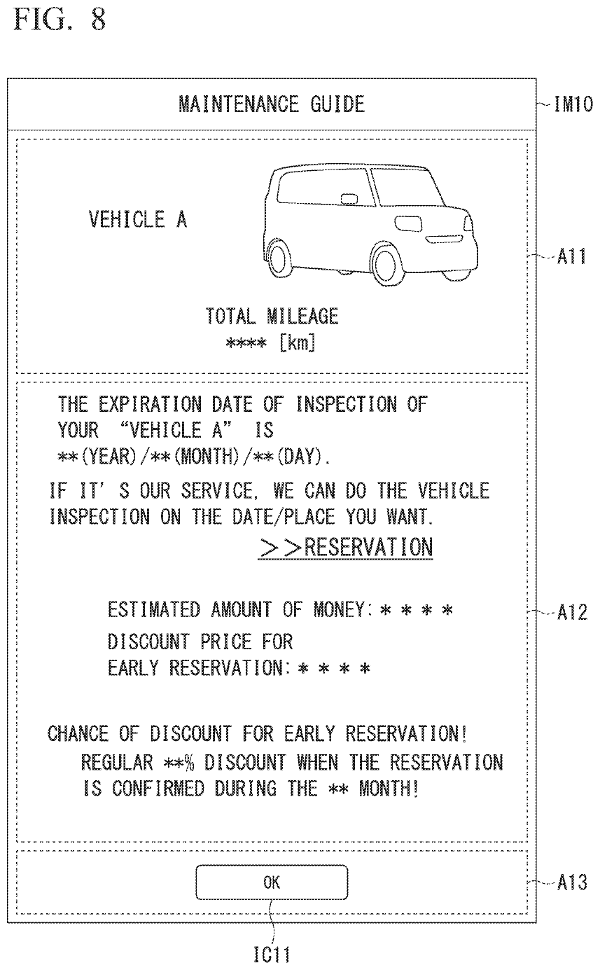

The maintenance management application 292 of the user terminal 200 receives the maintenance guide image transmitted by the maintenance management server 100, and causes the display 230 to display the received image. FIG. 8 is a diagram showing an example of a maintenance guide image IM10 displayed on the user terminal 200. A display mode of the image IM10 such as the layout or the display content is not limited to the example of FIG. 8. It is assumed that a prescribed numerical value is displayed in “*” included in the image IM10. It is assumed that the same is also true for the examples of other images to be described below. The maintenance guide image IM10 shown in FIG. 8 includes, for example, a vehicle information display area A11, a maintenance guide information display area A12, and a switch display area A13. The vehicle information display area A11 includes, for example, information about the vehicle ID and the total mileage included in the vehicle information 184. The vehicle information display area A11 may include information about an image of the vehicle M included in the owned vehicle information of the user information 182. In the maintenance guide information display area A12, information about the vehicle inspection expiration date of the vehicle M, information about services that can be implemented by the maintenance management system 1, privilege information, and the like are displayed. In the maintenance guide information display area A12, text information to which a switch for transitioning to a reservation screen for making a reservation for maintenance or a hyperlink destination is assigned may be displayed. In the example of FIG. 8, text information such as “The expiration date of inspection of your vehicle A is **(year)/**(month)/**(day),” “If it's our service, we can do the vehicle inspection on the date/place you want,” “Estimated amount of money: ****,” “Discount price for early reservation: ****,” and “Chance of discount for early reservation! Regular **% discount when the reservation is confirmed during the ** month!” is displayed in the maintenance guide information display area A12. In the example of FIG. 8, text information to which a hyperlink destination such as “>>reservation” is assigned is displayed.

In the switch display area A13, for example, an icon IC11 for ending the display of the image IM10 is displayed. The icon IC11 is, for example, a graphical user interface (GUI) switch. The same is also true for the other icons to be described below. When a portion of “>>reservation” displayed on the screen by the user U1 has been selected (touched), the maintenance management application 292 transmits a display request for a reservation screen to the maintenance management server 100. The information provider 160 of the maintenance management server 100 generates an image (a maintenance reservation image) for making a maintenance reservation, provides the generated image to the user terminal 200, and causes the display 230 to display the generated image. When the icon IC11 has been selected, the maintenance management application 292 does not transition to the maintenance reservation image and ends the display of the image IM10.

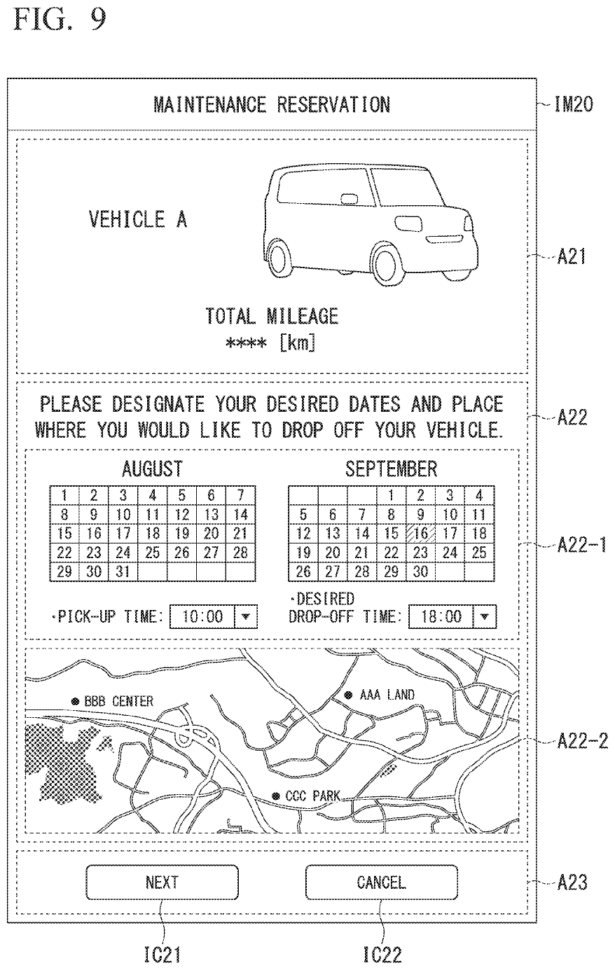

FIG. 9 is a diagram showing an example of a maintenance reservation image IM20. The maintenance reservation image IM20 shown in FIG. 9 includes, for example, a vehicle information display area A21, a desired date/time/place input area A22, and a switch display area A23. In the vehicle information display area A21, for example, information similar to that of the vehicle information display area A11 is displayed. The desired date/time/place input area A22 includes, for example, a desired date/time input area A22-1 and a desired place input area A22-2. In the desired date/time input area A22-1, for example, calendar information of a prescribed month is displayed such that a prescribed date (a designated date) can be input. In the calendar information, a vehicle inspection expiration date may be displayed to be distinguishable from other dates and a discount target period may be displayed to be distinguishable from other periods. In the desired date/time input area A22-1, for example, an area for inputting a pick-up time for delivery from the user U1 to a person in charge of the maintenance facility 300 (for example, a maintenance worker) and a desired drop-off time for delivery from the maintenance facility 300 to the user U1 is displayed. For each piece of time information, a desired time may be selected from a time list included in a combo box or the time may be directly input. In the desired place input area A22-2, map information is displayed such that a prescribed position (a designated place) can be input. The desired place input area A22-2 may include an area for inputting an address. Here, the place input by the desired place input area A22-2 includes one or both of a pick-up place and a drop-off place of the vehicle M. The pick-up place and the drop-off place may be the same place or different places. The place to be input may be, for example, a place where there is a maintenance facility 300 or a place where there is no maintenance facility. Therefore, the place to be input may be an excursion destination visited by the user U1 for a purpose other than maintenance of the vehicle M. The excursion destination is, for example, a place where the user U1 has moved the vehicle M for leisure, a date, shopping, commuting, or the like (for example, a theme park, a department store, a parking lot of a company, or a rotary area in front of a station). Thereby, the vehicle M can be picked up or dropped off at the excursion destination and the user U1 can enjoy leisure and dates during the maintenance of the vehicle M or perform shopping or the like and can effectively utilize the waiting time during the maintenance. In the embodiment, by designating the pick-up time and the desired drop-off time in advance, the vehicle M can be picked up by the person in charge of the maintenance facility 300 and the vehicle M can be dropped off smoothly by the person in charge. Thus, the user U1 can designate a place (a place where temporary parking for a short time is possible) other than the parking lot as a pick-up place or a drop-off place of the vehicle M. Therefore, the vehicle M can be delivered at a place that meets the various needs of the user U1. A designated place P1 shown in FIG. 7 indicates a pick-up place and a drop-off place (for example, a parking lot of a race watching field or an amusement park) designated (input) by the user U1.

In the switch display area A23, for example, an icon IC21 for transitioning to a screen for inputting information (for example, maintenance content) other than the information set in the desired date/time/place input area A22 and an icon IC22 for ending the display of an image IM20 are displayed. When the icon IC21 has been selected, the maintenance management application 292 transmits a display request for the next maintenance reservation image to the maintenance management server 100. The information provider 160 of the maintenance management server 100 generates the next maintenance reservation image, provides the generated next maintenance reservation image to the user terminal 200, and causes the display 230 to display the generated next maintenance reservation image. When the icon IC22 has been selected, the maintenance management application 292 cancels the reservation and ends the display of the image IM20.

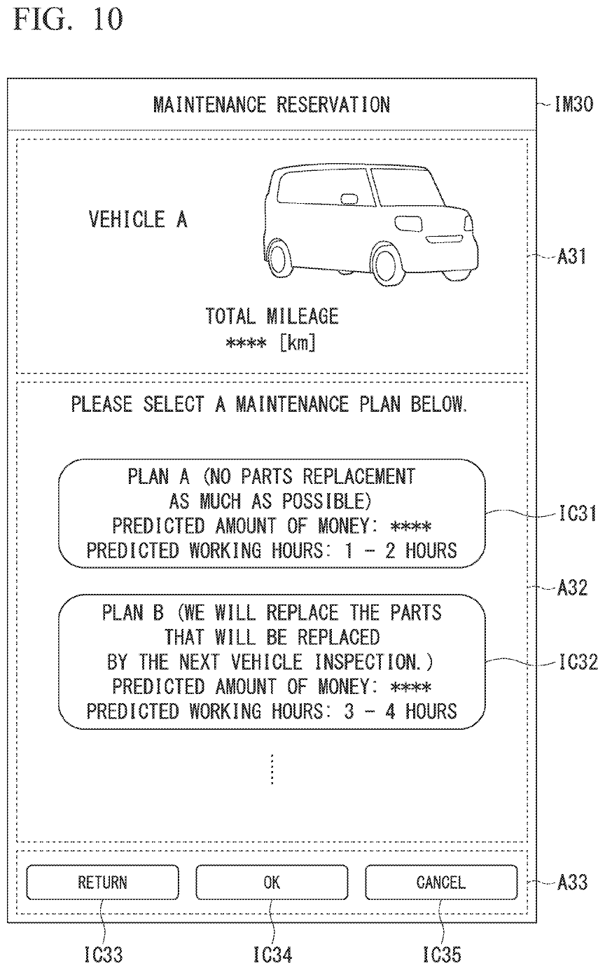

FIG. 10 is a diagram showing an example of a maintenance reservation image IM30. The maintenance reservation image IM30 shown in FIG. 10 includes, for example, a vehicle information display area A31, a maintenance plan input area A32, and a switch display area A33. Information similar to that of the vehicle information display area A11 is displayed in the vehicle information display area A31. In the maintenance plan input area A32, information about a plurality of preset maintenance plans (maintenance content) is displayed. In the example of FIG. 10, in the maintenance plan input area A32, icons IC31 and IC32 for displaying detailed information (for example, a predicted amount of money and predicted working hours) of each plan of plan A and plan B are displayed. In the example of FIG. 10, plan A is a plan in which parts are not replaced as much as possible. Plan B is a plan to replace parts that will be replaced by the next vehicle inspection. Because the maintenance content of each plan is different, the user U1 can select a desired maintenance plan in accordance with the amount of money or the working hours. The maintenance plan input area A32 may include an input area for allowing the user U1 to input specific maintenance content (for example, replacement or repair of prescribed parts) in addition to displaying a predetermined plan.

In the switch display area A33, for example, an icon IC33 for returning to the maintenance reservation image IM20 shown in FIG. 9, an icon IC34 for transmitting reservation information (an example of the maintenance request) input through the maintenance reservation images IM20 and IM30 to the maintenance management server 100, and an icon IC35 for canceling the reservation and ending the display of the image IM30 are displayed. When the icon IC33 has been selected, the maintenance management application 292 transmits a display request for the previous maintenance reservation image IM20 to the maintenance management server 100. The information provider 160 of the maintenance management server 100 provides the maintenance reservation image IM20 to the user terminal 200 and causes the display 230 to display the maintenance reservation image IM20. When the icon IC34 has been selected, the maintenance management application 292 transmits the input reservation information to the maintenance management server 100. When the icon IC35 has been selected, the maintenance management application 292 cancels the reservation and ends the display of the image IM30. In addition to the above-described information, the reservation information may include, for example, information such as whether or not to use a substitute vehicle during maintenance.

Returning to FIG. 7, (2) of FIG. 7 indicates that the input reservation information (maintenance request) has been transmitted to the maintenance management server 100 by selecting the icon IC34. The processes of (1) and (2) of FIG. 7 may be iteratively executed such that the above-described images IM10 to IM30 are displayed. Next, the acquirer 130 acquires maintenance facility information from each of a plurality of maintenance facilities (maintenance facilities 300-1 to 300-4 in the example of FIG. 7) managed by the maintenance management server 100 ((3-1) to (3-4) of FIG. 7). Here, when the reservation information has been acquired from the user terminal 200, the acquirer 130 may cause an acquisition request for the maintenance facility information to be transmitted to the maintenance facilities 300-1 to 300-4 through the manager 140 and acquire the latest maintenance facility information (for example, availability and privilege information) of each maintenance facility. The acquirer 130 may cause a notification of the reservation information to be provided to the maintenance facilities 300-1 to 300-4 through the manager 140 and acquire maintenance information for the vehicle M from the maintenance facilities 300-1 to 300-4. The maintenance information includes, for example, information indicating whether maintenance corresponding to maintenance content of the reservation information is possible and/or maintenance facility information.

In the processes of (3-1) to (3-4) of FIG. 7, instead of the above-described processes, the information provider 160 may provide (publish) the reservation information (the maintenance request) for vehicle M on the web in a state in which access from the maintenance facilities 300-1 to 300-4 is possible and acquire information such as whether maintenance corresponding to the reservation information can be carried out from each of maintenance facilities 300-1 to 300-4, costs, privileges, and the like. The information acquired from the maintenance facilities 300-1 to 300-4 is stored as the maintenance facility information 186 in the storage 180.

Next, the selector 150 selects a maintenance facility for requesting maintenance of the vehicle M from a plurality of maintenance facilities 300-1 to 300-4 on the basis of the reservation information and the maintenance facility information 186. In this case, the selector 150 selects a maintenance facility using, for example, a function based on artificial intelligence (AI). Specifically, the selector 150 selects a maintenance facility having highest availability among a plurality of maintenance facilities for which information indicating that maintenance of the vehicle M is possible is acquired (hereinafter simply referred to as a “plurality of maintenance facilities”). The selector 150 may extract a maintenance facility nearest a designated position P1 (a pick-up place or a drop-off place) from among the plurality of maintenance facilities. The selector 150 may select a maintenance facility whose maintenance cost (money amount) is lowest. On the basis of the privilege information, the selector 150 may select a maintenance facility having the most fulfilling services (for example, in which a car wash is included, the discount rate or the number of given privilege points is maximum, a free gift is most expensive, or the like). The selector 150 may select a maintenance facility having the highest evaluation of the evaluation information included in the maintenance facility information among the plurality of maintenance facilities. The selector 150 may select a maintenance facility having the lowest sales in a prescribed period (for example, monthly) among the plurality of maintenance facilities. The selector 150 may select the most frequently used maintenance facility among the maintenance facilities that previously carried out maintenance included in a maintenance history included in the vehicle information 184. The selector 150 may comprehensively determine selection results of the plurality of selection methods described above and finally select a maintenance facility.

The selector 150 may select a maintenance facility for requesting maintenance of the vehicle M using, for example, a bidding method. In this case, the selector 150 transmits information (maintenance facility information) about a maintenance facility (a maintenance facility satisfying the condition of the reservation information) where maintenance of the vehicle M is possible to the user terminal 200 and selects the maintenance facility selected by the user U1 as a maintenance facility for requesting maintenance of vehicle M. The selector 150 may select a maintenance facility that has input information indicating that the maintenance of the vehicle M can be carried out most rapidly with respect to the reservation information (the maintenance request) of the vehicle M published on the web as a highest-priority maintenance facility for requesting the maintenance of the vehicle M. The selector 150 may select a maintenance facility for requesting maintenance of the vehicle M on the basis of a priority level of the maintenance facility information set in advance by the user U1. For example, the selector 150 selects a maintenance facility having the lowest work cost when the user U1 prioritizes the work cost over other items and selects a maintenance facility having highest evaluation when the user U1 prioritizes the evaluation information over the other items.

In the example of FIG. 7, it is assumed that the maintenance facility 300-4 has been selected. By using the above-described selection method, for example, it is possible to select a maintenance facility in an area (for example, city B) other than an area (for example, city A) where the designated place P1 is present. The information provider 160 transmits information indicating that a maintenance facility for requesting maintenance of the vehicle M has been selected, reservation information, vehicle information, and the like to the maintenance facility 300-4 ((4) of FIG. 7). The information provider 160 may transmit information indicating that the maintenance facility has been decided on and/or maintenance facility information of the selected maintenance facility to the user terminal 200.

Next, the person in charge of the maintenance facility 300-4 moves to the designated place P1 to pick up the vehicle M on the date/time included in the reservation information ((5) of FIG. 7). The person in charge can identify the vehicle from the designated place P1 on the basis of the vehicle information. After the vehicle M is picked up from the user U1 at the pick-up time, the vehicle M is returned to the maintenance facility 300-4 to carry out maintenance of the vehicle M ((6) of FIG. 7). After the maintenance is completed, the person in charge of the maintenance facility 300-4 moves the vehicle M after the maintenance to the designated place P1 and drops off the vehicle M for delivery to the user U1 at the point P1 ((7) of FIG. 7). At the time of drop-off, the work cost is paid by banknotes, electronic payment, credit card payment, or the like.

Before or during the maintenance of the vehicle M in the above-described process of (6) of FIG. 7, the maintenance facility 300-4 may generate an image (an additional confirmation image) for allowing the user U1 to confirm whether or not additional parts need to be replaced and transmit the generated additional confirmation image to the user terminal 200.

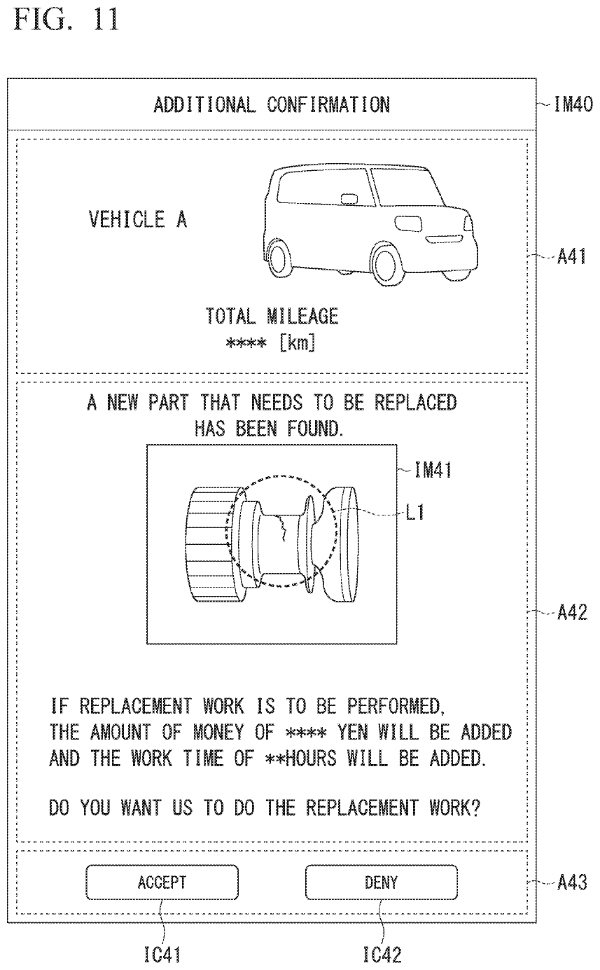

FIG. 11 is a diagram showing an example of an additional confirmation image IM40. The additional confirmation image IM40 shown in FIG. 11 includes, for example, a vehicle information display area A41, an additional maintenance information display area A42, and a switch display area A43. Information similar to that of the vehicle information display area A11 is displayed in the vehicle information display area A41. In the additional maintenance information display area A42, information about additional maintenance (replacement or repair) is displayed in addition to the maintenance plan included in the reservation information. An image of a part to be replaced (for example, an actual image of a part mounted in the vehicle M) may be displayed in the additional maintenance information display area A42. In the example of FIG. 11, in the additional maintenance information display area A42, text information of “A new part that needs to be replaced has been found,” an image IM41 including a target part (for example, a drive shaft boot), text information of “If replacement work is to be performed, the amount of money of **** yen will be added and the work time of **hours will be added,” and text information of “Do you want us to do the replacement work?” are displayed. An enclosed line L1 may be displayed on the image IM41 such that the user U1 is allowed to recognize the target part easily.

In the switch display area A43, for example, an icon IC41 for accepting additional maintenance (replacement work) displayed in the additional maintenance information display area A42 and an icon IC42 for denying the additional maintenance are displayed. When the icon IC41 has been selected, the maintenance management application 292 transmits information indicating that the additional maintenance has been accepted to the maintenance facility 300-4 and the maintenance facility 300-4 carries out the maintenance of the vehicle M. When the icon IC42 has been selected, the maintenance management application 292 transmits information indicating that the additional maintenance has been denied to the maintenance facility 300-4. In this case, the additional maintenance of the vehicle M is not carried out. At the timing of the process of (6) of FIG. 7 described above, an image for confirming the final plan or the final estimate of the vehicle M may be displayed instead of (or in addition to) the additional confirmation image IM40. The facility terminal 310 may transmit progress information of the maintenance work to the user terminal 200 at a prescribed timing (for example, a prescribed cycle) of (6) of FIG. 7 described above. Thereby, the user U1 can complete things to do and the like at the excursion destination in accordance with the progress.

The maintenance facility 300 and the user terminal 200 may communicate with each other via the maintenance management server 100. Thereby, the maintenance management server 100 can manage a state of the vehicle M or the maintenance facility 300 even after the maintenance facility 300 for maintaining the vehicle M is selected.

As described above, according to the present embodiment, the user U1 can request the maintenance of the vehicle M using a time period in which the vehicle M is not used at the excursion destination for a prescribed purpose. Although the maintenance guide image IM10 from the maintenance management server 100 is displayed on the user terminal 200 in the process of (1) of FIG. 7 in the example of FIG. 7, the maintenance management server 100 is accessed from the user terminal 200 and reservation information using the images after the image IM20 is set in a state in which the maintenance guide image IM10 is not displayed when the user U1 replaces or repairs the parts of the vehicle M at the excursion destination.

### [Processing Sequence]

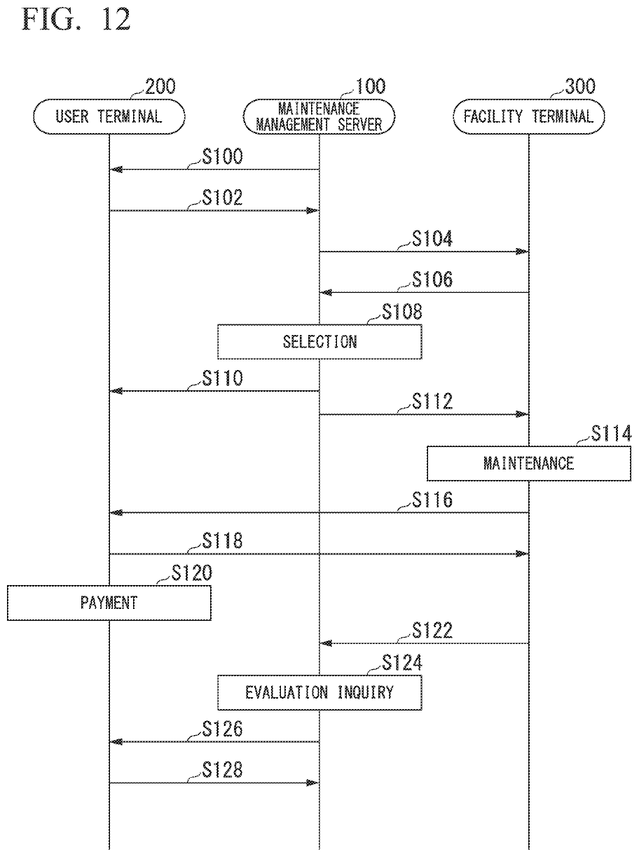

FIG. 12 is a sequence diagram showing an example of a process executed by the maintenance management system 1 according to the embodiment. In FIG. 12, the example of the process using the maintenance management server 100, the user terminal 200, and the maintenance facility 300 is shown. There may be a plurality of maintenance facilities 300. In the example of FIG. 12, it is assumed that an authentication process of the user terminal 200 is completed. In the example of FIG. 12, the maintenance management server 100 transmits guide information (for example, the maintenance guide image IM10) for requesting maintenance of the vehicle M and provides a notification to the user U1 (step S100). The user terminal 200 receives guide information about maintenance and inputs maintenance reservation information (a maintenance request) using the maintenance reservation images IM20 and IM30 and the like described above (step S102).

Subsequently, when the reservation information has been acquired from the user terminal 200, the maintenance management server 100 transmits a request for acquiring the current (latest) maintenance facility information to one or more maintenance facilities 300 (step S104). The maintenance facility 300 transmits information such as currently feasible maintenance content, availability, and privilege information to the maintenance management server 100 (step S106). Next, the maintenance management server 100 selects a maintenance facility 300 for requesting maintenance included in the reservation information on the basis of the user terminal 200 and the maintenance facility information acquired from the maintenance facility 300 (step S108).

Subsequently, the maintenance management server 100 transmits information indicating that maintenance can be carried out included in the reservation information, information about the selected maintenance facility 300, and the like to the user terminal 200 (step S110). The maintenance management server 100 transmits information indicating that the maintenance facility for carrying out the maintenance has been selected, reservation information, vehicle information, and the like to the maintenance facility 300 for carrying out the maintenance of the vehicle M (step S112). Thereby, the user U1 can deliver the vehicle M to the person in charge of the maintenance facility 300 at the pick-up date/time and place included in the reservation information. Subsequently, the maintenance facility 300 carries out maintenance based on the reservation information (step S114).

Here, when it is determined that additional parts need to be replaced before or during maintenance, the maintenance facility 300 transmits inquiry (additional confirmation image) information about whether or not the parts need to be replaced to the user terminal 200 (step S116). Subsequently, the user terminal 200 displays the additional confirmation image transmitted from the maintenance facility 300 and transmits information about acceptance or denial from the user U1 to the maintenance facility 300 (step S118). Thereby, even if additional parts are replaced before or during maintenance, it is possible to confirm with the user U1 and carry out more appropriate maintenance. By confirming with the user U1 by presenting an image during the work, the correctness and reliability of the work can be improved. In the processing of steps S116 and S118, the transmission may be performed via the maintenance management server 100. Thereby, the maintenance management server 100 can manage a maintenance state in more detail.

Subsequently, after the maintenance is completed in the maintenance facility 300, the person in charge of the maintenance facility 300 moves the vehicle M after the maintenance to a designated position and delivers the vehicle M to the user U1. The user terminal 200 performs an electronic payment process for the maintenance cost (step S120). After the payment is completed, the maintenance facility 300 transmits information about a payment amount and/or final maintenance content (for example, a maintenance history) to the maintenance management server 100 (step S122).

The maintenance management server 100 stores information transmitted from the maintenance facility in the vehicle information 184, generates inquiry information about the evaluation of the maintenance facility 300 that has carried out maintenance (step S124), and transmits the generated inquiry information to the user terminal 200 (step S126). The user terminal 200 receives the inquiry information and transmits response information (an evaluation result) to the inquiry input by the user's operation to the maintenance management server 100 (step S128). The evaluation result may be, for example, a five-grade evaluation, an evaluation result in which “YES” or “NO” has been input to a plurality of questionnaires, or other index values indicating the goodness of the evaluation. The maintenance management server 100 updates the evaluation information of the maintenance facility information 186 on the basis of an input evaluation result.

In the process of FIG. 12, in step S104, a request for acquiring the current (latest) maintenance facility information is transmitted to one or more maintenance facilities 300. However, instead of this, the reservation information acquired from the user terminal 200 may be published on the web and a maintenance facility 300 for requesting the maintenance of the vehicle M may be selected on the basis of the maintenance facility information input on the basis of information published by the maintenance facility 300.

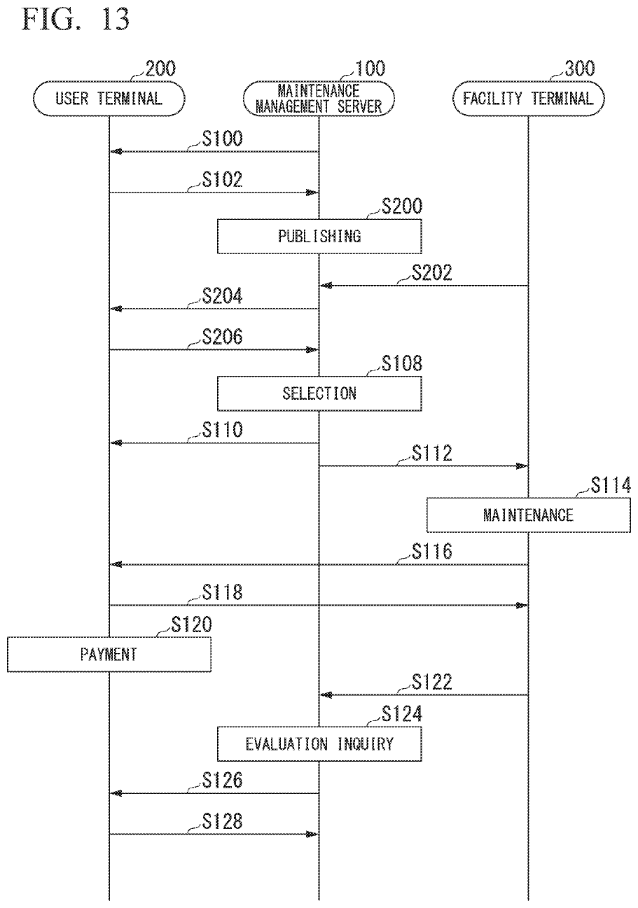

FIG. 13 is a sequence diagram showing an example of other processes executed by the maintenance management system 1 according to the embodiment. In FIG. 13, as compared with steps S100 to S128 of the sequence of FIG. 12, there is a difference that steps S200 to S206 are provided instead of steps S104 and S106. Therefore, the processing of steps S200 to S206 will be mainly described below.

In the processing of step S102 of FIG. 13, after the reservation information is acquired from the user terminal 200, the maintenance management server 100 publishes the acquired reservation information on the web such that the published information can be viewed in the maintenance facility 300 (step S200). In the processing of step S200, the maintenance management server 100 may notify the maintenance facility 300 that the reservation information has been published. Subsequently, the maintenance facility 300 refers to the published reservation information and inputs the maintenance information including the maintenance facility information to the maintenance management server 100 if the maintenance can be carried out (step S202). The maintenance management server 100 transmits maintenance information from the plurality of maintenance facilities 300 to the user terminal 200 and notifies the user U1 of the maintenance information (step S204) and acquires information of the maintenance facility 300 selected by the user U1 using the user terminal 200 (step S206). The maintenance management server 100 selects the maintenance facility 300 selected by the user U1 as the maintenance facility for requesting the maintenance of the vehicle M (step S108).

According to a process of the so-called bidding method as shown in FIG. 13, in addition to having effects similar to those of the process shown in FIG. 12, it is possible to select the maintenance facility 300 for requesting the maintenance according to maintenance facility information input with respect to published reservation information in a state in which the maintenance management server 100 does not manage the maintenance facility 300 in advance. Therefore, the number of targets to be managed by the maintenance management server 100 can be reduced and the processing load of the maintenance management server 100 can be reduced. According to the process of FIG. 13, for example, the number of maintenance requests can be increased and the sales can be increased by participating in the bidding at the will of the maintenance facility side even if the pick-up place is not in the suburbs.

According to the above-described embodiment, the maintenance management server 100 includes the acquirer 130 configured to acquire a maintenance request for the vehicle M; the manager 140 configured to manage information about maintenance facilities 300 where a maintenance process for the vehicle M is possible; and the selector 150 configured to select a maintenance facility 300 for which the maintenance process for the vehicle M is requested on the basis of information about a desired date of a user of the vehicle M, a place, and maintenance content included in the maintenance request acquired by the acquirer 130 and the information about the maintenance facilities 300. Thereby, it is possible to provide a more appropriate maintenance facility with respect to the maintenance request for the vehicle M. Therefore, the user can spend the waiting time meaningfully during the vehicle maintenance.

Specifically, according to the embodiment, the maintenance management server 100 manages the states of the vehicle M of the user U1 and the maintenance facility 300, such that the interaction (the burden and the trouble) between the user U1 associated with the maintenance of the vehicle M and the maintenance facility 300 can be reduced. According to the embodiment, on the day of the maintenance work day, the vehicle M may be picked up and dropped off at a designated place (including an excursion destination) and a designated time of the user. Thus, the user can finish other things to do at other times (time during maintenance) and can effectively utilize the time. According to the embodiment, when additional confirmation items or the like have occurred during maintenance, appropriate maintenance work can be carried out in a simple acceptance or denial procedure between the user terminal 200 and the maintenance facility 300.

By introducing a system as shown in the embodiment, for example, in consideration of the user's time constraint due to maintenance and the like, maintenance work can be carried out using the user's excursion destination to provide maintenance equipment that meets user needs and it is possible to develop business having an advantage over other services. Therefore, it is possible to limit the outflow of customers to other maintenance facilities and the like that are not registered in the system and it is possible to increase the sales of vehicle-related parts. On the maintenance facility side, even if there is a prior contract in the initial maintenance plan of the maintenance facility, other working hours can be adjusted in advance in accordance with the reservation information, such that the number of maintenance requests can be increased and sales can be increased.

The embodiment described above can be represented as follows.

A maintenance management device including:

a storage device storing a program; and

a hardware processor,

wherein the hardware processor executes the program stored in the storage device to:

acquire a maintenance request for a vehicle;

manage information about maintenance facilities where vehicle maintenance is possible; and

select a maintenance facility for requesting the vehicle maintenance on the basis of information about a desired date of a user of the vehicle, a place, and maintenance content included in the acquired maintenance request and the information about the maintenance facilities.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A maintenance management device comprising:
an acquirer configured to acquire a maintenance request for a vehicle;
a manager configured to manage information about maintenance facilities where vehicle maintenance is possible; and
a selector configured to select a maintenance facility for requesting the vehicle maintenance on the basis of information about a desired date of a user of the vehicle, a place, and maintenance content included in the maintenance request acquired by the acquirer and the information about the maintenance facilities.

2. The maintenance management device according to claim 1, wherein the manager manages vehicle information of the user and notifies the user of information for requesting the user to perform the vehicle maintenance on the basis of the vehicle information.

3. The maintenance management device according to claim 1,
wherein the manager notifies the maintenance facility managed by the manager of the maintenance request acquired by the acquirer, and
wherein the selector selects the maintenance facility for requesting the vehicle maintenance on the basis of the maintenance information for the vehicle acquired by the acquirer from the maintenance facility.

4. The maintenance management device according to claim 1, wherein, when the acquirer has acquired maintenance information for the vehicle from a plurality of maintenance facilities, the selector notifies the user of the maintenance information for the vehicle in relation to each maintenance facility and selects a maintenance facility selected by the user as the maintenance facility for requesting the vehicle maintenance.

5. The maintenance management device according to claim 1, wherein the place includes one or both of a vehicle pick-up place and a vehicle drop-off place.

6. The maintenance management device according to claim 1, wherein the place is a place where there is no maintenance facility.

7. The maintenance management device according to claim 1, wherein the place is an excursion destination visited by the user for a purpose other than the vehicle maintenance.

8. A maintenance management system including a user terminal used by a user of a vehicle, maintenance facilities where vehicle maintenance is possible, and a maintenance management device configured to communicate with the user terminal and the maintenance facilities, wherein the maintenance management device includes
an acquirer configured to acquire a maintenance request for the vehicle input through the user terminal;
a manager configured to manage maintenance facility information based on the maintenance request from the maintenance facilities;
a selector configured to select a maintenance facility for requesting the vehicle maintenance on the basis of information about a desired date of a user of the vehicle, a place, and maintenance content included in the maintenance request acquired by the acquirer and the maintenance facility information; and
an information provider configured to provide information based on a selection result of the selector to the user terminal and the maintenance facility selected by the selector.

9. A maintenance management method comprising:
acquiring, by a computer, a maintenance request for a vehicle;
managing, by the computer, information about maintenance facilities where vehicle maintenance is possible; and
selecting, by the computer, a maintenance facility for requesting the vehicle maintenance on the basis of information about a desired date of a user of the vehicle, a place, and maintenance content included in the acquired maintenance request and the information about the maintenance facilities.

10. A computer-readable non-transitory storage medium storing a program for causing a computer to:
acquire a maintenance request for a vehicle;
manage information about maintenance facilities where vehicle maintenance is possible; and
select a maintenance facility for requesting the vehicle maintenance on the basis of information about a desired date of a user of the vehicle, a place, and maintenance content included in the acquired maintenance request and the information about the maintenance facilities.
